(19) United States
(12) Patent Application Publication
(10) Pub. No.: US 2006/0172613 A1
(43) Pub. Date: Aug. 3, 2006

(54) Pressure contact holding-type connector

(76) Inventor: Yuichiro Sasaki, Shiojiri-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/549,153

(22) PCT Filed: Mar. 16, 2004
(86) PCT No.: PCT/JP04/03476

§ 371 Date: Apr. 13, 2006

(30) Foreign Application Priority Data
Mar. 18, 2003 (JP) 2003-073769

(51) Int. Cl. H01R 13/24

(52) U.S. Cl. 439/824

(57) ABSTRACT

The pressure contact holding-type connector in accordance with the present invention is configured to be interposed between opposing electrodes; a conductive pin is located in at least one end portion of each through-hole of an insulating housing having a through-hole oriented in the thickness direction; a flange section provided at the conductive pin is mated with a small-diameter section provided in one end portion of the through-hole to maintain at least part of the conductive pin in a state of accommodation inside the through-hole; and a conductive coil spring having one end thereof mated with the flange section provided at the conductive pin and pushing the conductive pin with a snap to the outside of the through-hole is installed inside the through-hole. The conductive pin can be disposed at both ends of the coil spring.

### TECHNICAL FIELD

The present invention relates to a pressure contact holding-type connector, and more particularly to a pressure contact holding-type connector in which a conductive pin of the connector does not slip out of the housing.

### BACKGROUND ART

Connector pins for electric connection are known as means for conductively connecting via elastic contact and providing signal transfer between electronic circuits on a pair of boards disposed opposite each other in a variety of electronic devices (see Japanese Patent Application Laid-open No. H7-161401). Furthermore, the inventor suggested pressure contact holding-type connectors with improved connector pins for electric connection (Japanese Patent Applications Laid-open No. 2002-100431, 2002-158052, and 2002-158053).

The connector pin for electric connection (Japanese Patent Application Laid-open No. H7-161401) is described, as shown in FIG. 10, as a connector 46 for electric connection, comprising a connector pin 43 that is stretchably and slidably fitted into a tubular body 41, locked inside thereof, and impelled in the stretching direction by a spring 42 located inside the tubular body 41 and providing for electric conduction between the connector pin 43 and tubular body 41 via a sliding contact section of the outer peripheral surface 44 of the mating section of the connector pin 43 and the inner peripheral surface 45 of the tubular body 41 in a compressed state of the connector pin 43, wherein a small-diameter relief section 47 is provided over a wide area, except the two end sections in the axial direction, at the outer peripheral surface 44 of the mating section of the connector pin 43.

In the connector for electric connection shown in FIG. 10, because a contact terminal is inserted into a board and fixed therein by soldering, there is a not-insignificant risk of degrading assemblability. Furthermore, because the tubular body 41 is used, the diameter of the connector pin 43 increases and also the connector pins 43 are difficult to arrange with a fine pitch (for example, 1.2 mm or less).

The pressure contact holding-type connector (Japanese Patent Application Laid-open No. 2002-158053), in which the connector pin for electric connection was improved is a pressure contact holding-type connector 54 comprising, as shown in FIG. 11, an insulating housing 48, a plurality of through-holes 49 provided in the thickness direction of the housing 48, nearly cap-like conductive toe-pins 50 slidably fitted from one surface side of the housing 48 into each through-hole 49, conductive pins 51 slidably fitted from the other surface side of the housing 48 into the through-holes 49 and also fitted into the conductive toe-pins 50, and springs 53 fitted into each through-hole 49, brought into contact with the open end sections 52 of the conductive toe-pins 50, and passing through to the conductive pins 51, wherein the conductive toe-pins 50 and conductive pins 51 are caused to protrude from the housing 48 by the thrusting force of the spring 53.

This pressure contact holding-type connector shown in FIG. 11 can be mounted on the electronic circuit board itself. The end portions of the conductive pins comprising pins using, for example, gold-plated conductive copper, brass, aluminum, or conductive elastomer are formed to have a shape sharpened at the prescribed angle or a pointed shape of a cone, pyramid, or the like, so that they can break the oxide film present on the solder of the electrodes that are to be connected, thereby enabling good conduction. Furthermore, because the conductive toe-pins 50 and conductive pins 51 are always in direct contact and form the shortest conduction path, the conduction path is reduced, inductance can be greatly decreased, and a high frequency characteristic can be realized. In addition, the entire length of the conductive pins 51 can be reduced. However, because the conductive toe-pins 50 and conductive pins 51 are in sliding contact on the peripheral surfaces thereof, a pressure force necessary to provide for conduction between the electrodes increases. Furthermore, because the conductive pins 51 pass through inside the coil of the spring 53 in a locked state, the stroke of the conductive pins tends to be relatively small by comparison with the entire length of the spring.

In the modification example of the pressure contact holding-type connector of this type (Japanese Patent Application Laid-open No. 2002-158053), which is not shown in the figures, the conductive pin is provided with a flange section, which is engaged with a small-diameter section of the housing to prevent the conductive pin from slipping out of the housing.

The pressure contact holding-type connector of another type in which the connector pin for electric connection was improved (Japanese Patent Application Laid-open No. 2002-100431) is a pressure contact holding-type connector 55 that is to be interposed and held between the opposing electrodes, wherein conductive spring elements 60 formed to have an nearly conical shape are fitted into through-holes 56 of an insulating housing 57 having a plurality of through-holes 56 oriented in the thickness direction. The diameter of at least one end portion of the spring element is formed larger than the diameter of the other end portions, a cap 58 is mounted on the large-diameter end portion, a plug 59 is mounted on the distal end, and the spring element is provided so as to protrude from the surface of the housing 57 at the side of the other end portion. Electric conduction is ensured from the plug 59 that is in contact with one electrode to the cap that is in contact with the other electrode via the spring element 60 that has good conductivity.

In the pressure contact holding-type connector of this type, the length of the plug 59 can be decreased by mating the end portion of the spring element 60 with a toric neck section provided in the plug 59 and almost the entire length of the spring element 60 can serve as a stroke for the plug 59. Another specific feature is because the connector has no sliding contact sections with surface contact, the pushing force necessary to move the plug 59 back and forth can be reduced.

However, in the pressure contact holding-type connector of this type, because a rather large portion of the spring element 60 protrudes from the housing 57, this extending portion can be extended or deformed by an inadvertently applied external force during mounting, transportation, or maintenance or the plug 59 fitted into the spring element 60 can separate from the spring element 60.

### DISCLOSURE OF THE INVENTION

The present invention further improves the pressure contact holding-type connector shown in FIG. 12 and it is an object thereof to provide a pressure contact holding-type connector in which the deformation of the spring element and the separation of the plug from the spring element and damage of the plug are prevented.

The pressure contact holding-type connector in accordance with the present invention is a pressure contact holding-type connector to be interposed and held between opposing electrodes, wherein, in order to resolve the above-described problems, a conductive pin is located in at least one end portion of each through-hole of an insulating housing having the through-hole oriented in the thickness direction, a flange section provided at the conductive pin is mated with a small-diameter section provided in one end portion of the through-hole to maintain at least part of the conductive pin in a state of accommodation inside the through-hole, and a conductive coil spring having one end thereof mated with the flange section provided at the conductive pin and pushing the conductive pin with a snap to the outside of the through-hole is installed inside the through-hole. The conductive pin can be disposed at both ends of the coil spring.

Furthermore, it is preferred that an end stopper for preventing excess compression be provided between the housing and a circuit board or electronic component that is electrically connected by the pressure contact holding-type connector, the coil spring be formed to have a shape with respectively different coil diameters in adjacent turns, any corner on the lower side of the housing be chamfered, a rib for preventing a solder from wrapping-around be provided at the rear surface of the housing between disposed conductive plates, and the corner portions of the flange section of the conductive pin be rounded.

The present invention eliminates the risk of the connector, in particular the coil spring, being damaged or deformed. Furthermore, the load required for pushing can be decreased, stable connection can be provided, damage to the electrodes that are connected can be significantly reduced, and further miniaturization of the connector is attained.

### BRIEF DESCRIPTION OF THE DRAWINGS

FIG. 1 is a cross-sectional view illustrating an embodiment of the pressure contact holding-type connector in accordance with the present invention;

FIG. 2 illustrates an external appearance of the embodiment of the pressure contact holding-type connector in accordance with the present invention; (a) is a plan view (top view), (b) is a front view (vertical view), and (c) is a rear view;

FIG. 3 is an explanatory drawing illustrating another embodiment of the pressure contact holding-type connector in accordance with the present invention; (a) is a plan view (top view), (b) is a front view (vertical view) with a partial cross section, and (c) is a side view;

FIG. 4 is an enlarged cross-sectional view of the main portion shown in FIG. 3;

FIG. 5 is an explanatory drawing illustrating the third embodiment of the pressure contact holding-type connector in accordance with the present invention; (a) and (c) are front (vertical) explanatory drawings illustrating the state prior to mounting, and (b) and (d) are front (vertical) explanatory drawings illustrating the state during mounting;

FIG. 6 is an explanatory drawing illustrating the preferred embodiment of a coil spring used in the pressure contact holding-type connector in accordance with the present invention;

FIG. 7 is an explanatory drawing illustrating the preferred embodiment of a housing used in the pressure contact holding-type connector in accordance with the present invention;

FIG. 8 is an explanatory drawing illustrating the fourth embodiment of the pressure contact holding-type connector in accordance with the present invention;

FIG. 9 is an explanatory drawing illustrating the preferred embodiment of a conductive pin used in the pressure contact holding-type connector in accordance with the present invention;

FIG. 10 is an explanatory drawing illustrating a conventional connector pin for electric connection.

FIG. 11 is an explanatory drawing illustrating ae conventional pressure contact holding-type connector; and

FIG. 12 is an explanatory drawing illustrating a pressure contact holding-type connector of another conventional type.

### BEST MODE FOR CARRYING OUT THE INVENTION

The present invention is based on accommodating a spring element inside a through-hole provided in a housing.

The present invention will be described below in greater detail with reference to the appended drawings.

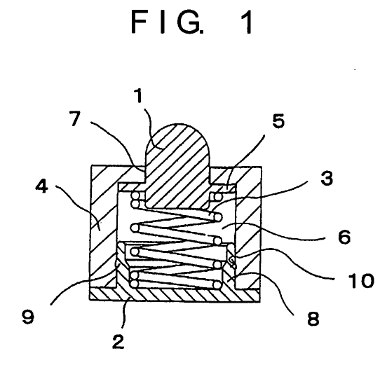

In FIG. 1, the reference numeral 1 stands for a conductive pin, 2—a conductive plate, 3—a coil spring, and 4—an insulating housing. A flange section 5 is formed at the conductive pin 1, and a through-hole 6 is formed in the housing 4. One end of the through-hole 6 is a small-diameter section 7. The flange section 5 of the conductive pin 1 accommodated inside the through-hole 6 of the housing 4 mates with a step of the portion of the small-diameter section 7 of the through-hole 6, thereby preventing the conductive pin 1 from being separated from slipping out of the housing 4. A head section of the conductive pin 1 can protrude from the housing 4.

The other end side of the housing 4 is enclosed with the conductive plate 2. A cylindrical section 8 of a diameter corresponding to the through-hole 6 of the housing 4 is provided in the conductive plate 2, and the cylindrical section 8 is press fitted into the through-hole 6 of the housing 4. It is preferred that a protruding section 9 provided on the outer periphery of the cylindrical section 8 engage with a mating recess 10 provided in the inner wall of the through-hole 6 of the housing 4 and be fixed therein.

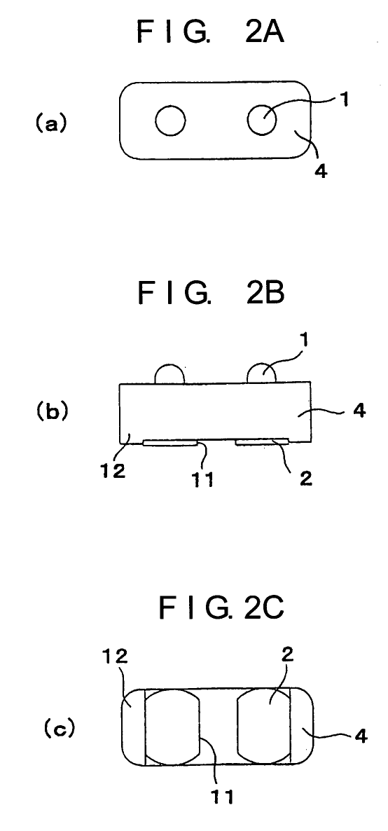

If necessary, a linear section 11 can be provided in the conductive plate 2, as shown in FIG. 2(c), thereby enabling the engagement with a positioning projection 12, which can be provided on the rear surface of the housing 4, and the alignment of the direction of insertion into the housing 4 with the desired direction.

The inner wall of the cylindrical section 8 has a small-diameter section in the bottom part thereof, and one end of the coil spring 3 is mated therewith and mounted in the fixed condition thereon. Further, the other end of the coil spring 3 is mated with the flange section 5 of the conductive pin 1 with a snap, thereby applying a pressure in the direction of separating the conductive pin 1 and the conductive plate 2.

In the example shown in FIG. 2, the bottom surface of the conductive plate 2 has a shape with a diameter equal to the width of the housing 4 and both sides cut along the arcs, but this shape is not limiting and any appropriate bottom surface can be used, provided that the size and shape thereof are such that it mates with the housing 4 and does not sink into the through-hole 6. For example, the bottom surface may have a round shape with a diameter smaller than the width of the housing 4.

The conductive pin 1 and conductive plate 2 are brought into contact with the electrodes of electronic parts or circuit board and are conductively connected between the electrodes.

The conductive pin 1 is fabricated by using, for example, gold-plated copper or a copper alloy such as brass, or a conductive elastomer. Furthermore, the head section of the conductive pin can have an appropriate shape, for example, a flat, semispherical, or conical shape, and the cross-sectional shape thereof may be round, angular, elliptical or oval. If it is in the form of a plurality of small cones or small pyramids, then when connection is made between electronic circuit boards, in particular, when the electrodes have been plated with solder, the oxide film of the solder is broken and reliable electric conduction is possible.

The conductive plate can be fabricated from the same material as the conductive pin. The cylindrical section provided in the conductive plate may be formed integrally with the conductive plate or may be formed separately and joined by an appropriate method, for example, by soldering or with a conductive adhesive.

The coil spring is formed as an resilient coil with a nearly cylindrical shape by winding a fine metal wire with a diameter, for example, 30-200 μm, preferably 50-100 μm with a uniform pitch (for example, 0.4 mm). A metal wire, for example, from phosphorus bronze, copper, beryllium copper, spring steel, hard steel, stainless steel, or piano wire or a metal wire obtained by plating those metallic wires with gold can be used as the fine metal wire for forming the coil spring.

From the standpoint of conduction resistance, it is preferred that a copper alloy with a small volume resistivity be used so that the coil spring form a conduction path, but because resilient properties of such an alloy are insufficient, brass, spring steel, stainless steel, and piano wire, which have a large modulus of elasticity, are recommended.

However, all those materials have a volume resistivity and conduction resistance higher than copper alloys. Therefore, for applications requiring a low conduction resistance, those wires are preferably plated with a thick layer (1-10 μm, preferably 3-5 μm) of a metal with a low volume resistivity, such as copper.

Furthermore, a gold layer is preferably plated as an outermost surface layer to decrease contact resistance. In this case, a nickel plating layer (2-3 μm) for diffusion prevention may be provided between the plated copper laying and gold plating layer.

The diameter of fine metal wire is selected within a range of 50-100 μm because low-load connection and low cost can be readily accomplished.

The housing can be formed to have a rectangular, square, polygonal, elliptical or oval profile. The housing may be provided with one through-hole, a plurality of through-holes arranged in one row, or a plurality of rows of through-holes arranged parallel to each other. Individual through-holes may be also arranged in a zigzag fashion in a plane. FIG. 2 illustrates the case where two through-holes are arranged in one row.

The insulating housing is formed by using a plastic for general applications that excels in heat resistance, dimensional stability, and moldability (for example, a polyamide resin, a polycarbonate, polypropylene, polyvinyl chloride, polyethylene). Among those materials, a polyamide resin is most preferred from the standpoint of processability and cost.

Another embodiment of the present invention will be described below. In the present embodiment, conductive pins are provided on both sides.

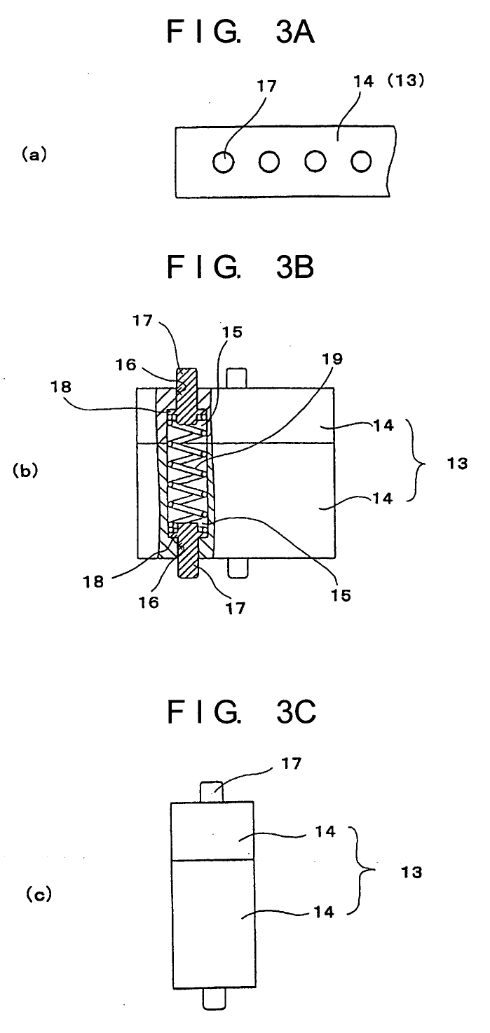

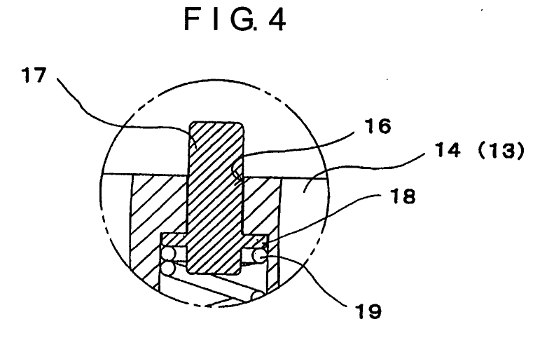

Referring to FIG. 3, a housing 13 comprises two housing plates 14, 14 and through-holes 15, 15 are formed in the housing plates 14, 14, respectively. One end section of the through-holes 15, 15 is a small-diameter section 16. Flange sections 18 of conductive pins 17, 17 accommodated inside the through-holes 15, 15 of the housing 13 (housing plates 14, 14) mate with steps of the portions of the small-diameter sections 16, 16 of the through-holes 15, 15, thereby preventing the conductive pins 17, 17 from slipping out of the housing 13 (housing plates 14, 14). Head sections of the conductive pins 17, 17 can protrude from the housing 13 (housing plates 14, 14).

The housing plates 14, 14 are assembled by aligning the through-holes 15, 15 on the opposite side from the small-diameter sections 16, 16 of the through-holes 15. The assembling may be conducted by adhesively bonding, welding, or clamping the housing plates 14, 14 together or the components may be fixed with appropriate means allowing them to be disassembled. Means such as positioning pins and holes are preferably provided for the convenience of assembling.

A coil spring 19 for causing the two conductive pins 17, 17 to protrude with a snap is inserted into the through-hole 15 of the housing 13 so as to mate with flange sections 18 of the conductive pins 17. The head sections of the conductive pins protrude to the outside of the housing 13.

The shape and material of the housing 13, the number and arrangement of the through-holes 15 provided in the housing 13, and the material and shape of the coil spring 19 are identical to those of the embodiment illustrated by FIG. 1 and FIG. 2 and the explanation thereof is not repeated herein.

The third embodiment of the pressure contact holding-type connector in accordance with the present invention will be described below.

Circuit boards or electronic components are disposed on both sides of the pressure contact holding-type connector, distance therebetween is reduced and electric connection is ensured by compressing the coil spring. In the case where the operation of reducing the distance is eventually stopped by a conductive pin, coil spring, conductive plate, or the like, because those components are fabricated mainly from a good conductor, excess compression thereof can result in deformation or damage. In order to avoid the excess compression, it is preferred that an end stopper for prevention of overly compression be provided in the pressure contact holding-type connector in accordance with the present invention between the housing and the circuit board or electronic component that are to be electrically connected.

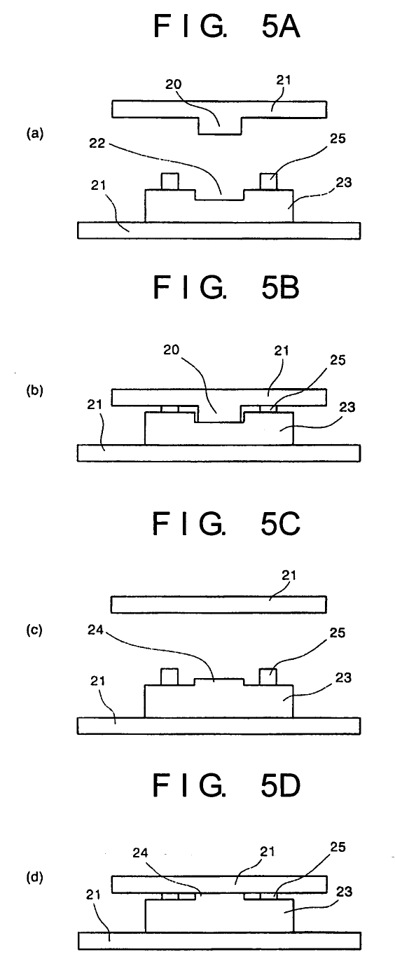

A mode of providing the end stopper is, for example, as shown in FIG. 5.

Protruding sections for reinforcement or the like are often present in circuit boards or electronic components. FIGS. 5(a), (b) illustrate an example in which those protruding sections are used as end stoppers. The reference numeral 20 stands for a protruding section of a circuit board or an electronic component 21, and the reference numeral 22 stands for a receding section provided in a housing 23 of a pressure contact holding-type connector. As shown in FIG. 5(b), during mounting, the protruding section 20 of the circuit board or electronic component 21 and the receding section 22 provided in a housing 23 abut against each other, thereby configuring an end stop.

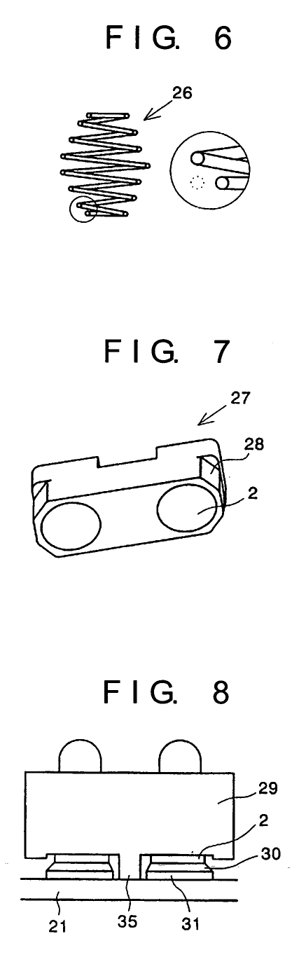

Furthermore, when the end stop is configured at the flat section of the circuit board or electronic component 21, as shown in FIG. 5(c) and FIG. 6(d), the protruding section 24 provided in the housing of the pressure contact holding-type connector and the circuit board or electronic component 21 abut against each other, thereby configuring the end stop. The reference numeral 25 stands for a conductive pin. In the example shown in the figure, it has a flat head section.

The number, shape, and size of the receding sections 22 and protruding sections 24 can be appropriately selected.

The preferred modification example of the coil spring will be explained below.

The coil spring used in the pressure contact holding-type connector in accordance with the present invention may be formed to have an almost cylindrical shape, as described hereinabove, to facilitate the fabrication thereof, but if the coil spring has an almost cylindrical shape, when it is compressed, in can be reduced in size only to the extent determined by the contact of the diameters of wire sections constituting the coil spring. Because of a demand for further miniaturization that was created in recent years, the reduction, even if little, in height of the connector housing is needed. In order to meet this demand, it is sometimes preferred that the adjacent coil turns be formed to have mutually different diameters, without reducing the elastic constant.

Examples of the coil springs 26 with the shape in which the adjacent coil turns have different diameters include a barrel-like coil shape with a larger diameter of the central portion thereof, as shown in FIG. 6, and a hourglass-like coil shape with a smaller diameter of the central portion thereof. As a result, as shown in the enlarged view on the right side of FIG. 6, the position of the wire turn located just above is shifted from the center of the wire turn located just below, as can be seen from a virtual projection circle shown by a dot line. The degree of this displacement is not limited to that of the example shown in the figure and can be set appropriately, for example, to less than half the diameter.

In the pressure contact holding-type connector in accordance with the present invention, various parts are vibration-aligned so as to be equidistantly accommodated in a special alignment jig. The final shape is formed by successive assembling.

The directionality of conductive pin, conductive plate, and coil spring during alignment is determined by specific features of individual shapes, but establishing the orientation of the housing is difficult.

Accordingly, the directionarity of the rear surface is revealed and alignment in the same direction is made possible by chamfering the corner in the direction of the rear surface of the housing and providing receding portions of the same shape in the alignment jig.

FIG. 7 illustrates the preferred mode of chamfering the corners on the lower side (the side faced by the conductive plate) of the housing. Thus, in the case illustrated by FIG. 7, chamfers 28 are provided in the corner portions on the lower surface of the housing 27 of the pressure contact holding-type connector.

In the example shown in the figure, the chamfers are provided in all the four inner corners, but because it is suffice to distinguish only the upper and lower surfaces of the housing, the size and number of the chamfers can be selected appropriately.

When the pressure contact holding-type connector in accordance with the present invention is mounted, usually, a solder paste is placed, for example, by using a printing technology on the prescribed section such as an electrode portion of circuit board, the conductive plate of the pressure contact holding-type connector is brought into contact with the paste, and soldering is conducted with a reflow furnace or the like. In this case, a large spacing between the conductive plates causes no problems, but in the case where only a spacing below a certain limit, for example, 0.2 mm (200 μm) can be provided, the molten solder can flow, causing mutual contact and conduction (short circuiting).

It is preferred that a rib for preventing the solder from wrapping-around be provided between the conductive plate of the housing so as to prevent contact between solder portions (short circuiting). As shown in FIG. 8, it is preferred that a rib 35 for preventing the solder from wrapping-around be provided between the conductive plates 2, 2 of the housing 29 of the pressure contact holding-type connector in accordance with the present invention.

The rib for preventing the solder from wrapping-around is in principle a rib of a uniform width provided over the entire length of the housing, but a variety of modifications are possible, for example, the rib can be in the form of a cylindrical wall surrounding the entire conductive plate. The rib for preventing the solder from wrapping-around preferably has a height equal to a total of the protrusion height of the conductive plate from the housing (for example, 0.065-0.085 μm), thickness of the solder 30 (for example, 0.03-0.05 μm), and height of the electrode 31 of the circuit board (for example, 0.035-0.055 μm) or a somewhat smaller height.

In the pressure contact holding-type connector in accordance with the present invention, the flange section of the conductive pin slides along the wall of the through-hole inside the through-hole provided in the housing. For this reason, the flange section is sometimes caught by the wall of the through-hole or the two scratch against each other. The compression force acting upon the connector and required for mounting is preferably reduced to a minimum. Accordingly, in order to reduce the sliding resistance or prevent scratching, it is preferred that the corner portions of the flange section of the conductive pin be subjected to rounding.

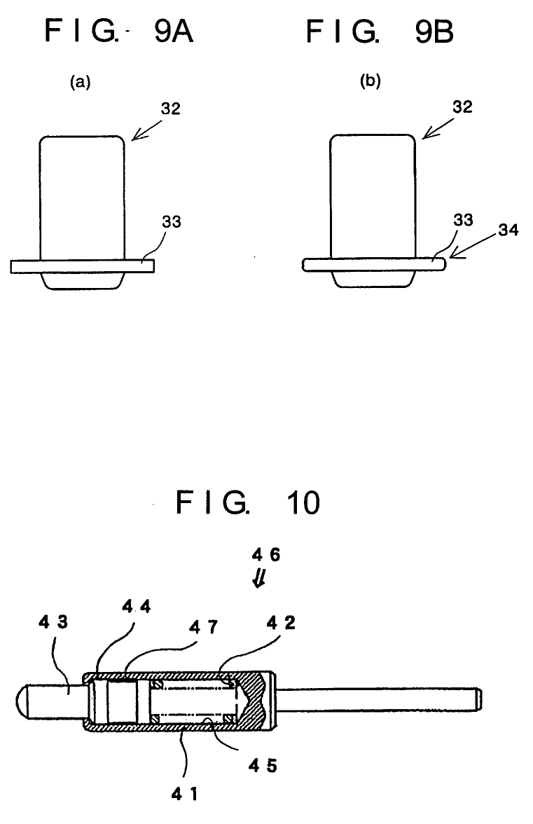

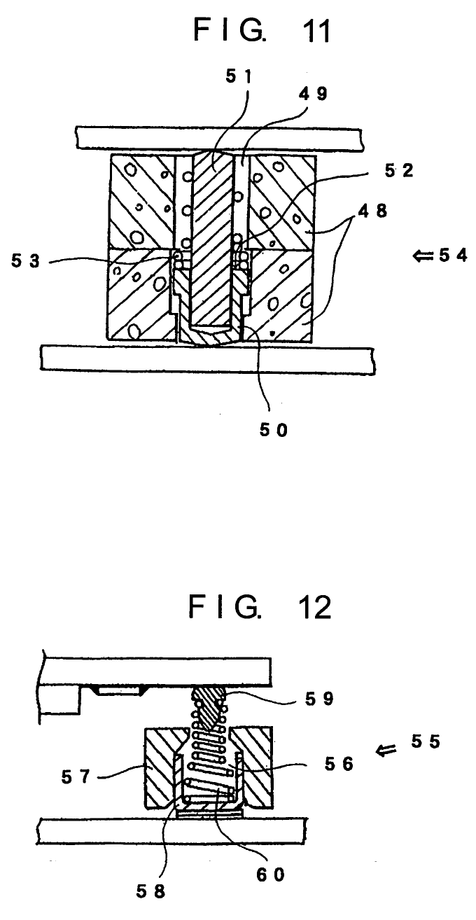

As shown in FIG. 9, the corner portions of the flange section 33 of the conductive pin are preferably subjected to rounding works 34. The rounding can be implemented by a suitable working means such as cutting, barreling, buffing, and electrolytic polishing (works).

### EXAMPLE

A fabrication example of the pressure contact holding-type connector in accordance with the present invention shown in FIG. 1 and FIG. 2 will be described below.

The housing having a length of 2 mm, width of 5 mm, and height of 2.1 mm was made from a polyamide resin. The conductive pin was fabricated from brass with gold plating. The coil spring was fabricated from a piano wire plated with a copper layer of a 4 μm thickness, then with a nickel layer of a 3 μm thickness and, as the outermost layer, with a gold layer of a 0.1 μm thickness and had a wire diameter, pitch, and length (during assembling) of 0.1 mm, 0.4 mm, and 1.3 mm, respectively.

The stroke was 0.5 mm, the pushing load was 1 N per conductive pin, and electric resistance between connected electrodes was 0.2 Ω per electrode pair.

### INDUSTRIAL UTILIZABILITY

By virtue of the successful accomplishment of compactness of connectors, a great advantages is obtained in further and further progressing compactness and light-weightness of IT instruments such as mobile phones, PDAs and the like.

1. A pressure contact holding-type connector characterized by, as a pressure contact holding-type connector to be press-held between opposite electrodes, comprising:
an insulating housing having a through-hole oriented in the direction of thickness;
a conductive pin mounted in at least one end portion of the through-hole, the conductive pin having a flange which comes into mating with a diameter-reduced portion provided in the through-hole at one end thereof so as to keep at least a part of the conductive pin in a state contained within the through-hole; and
a conductive coil spring mounted within the through-hole which comes into mating at one end thereof with the flange of the conductive pin so as to resiliently urge the conductive pin toward the direction of outside of the through-hole.

2. The pressure contact holding-type connector described in claim 1 in which conductive pins are disposed at both ends of the conductive coil spring.

3. The pressure contact holding-type connector described in claim 1 in which an end stop is provided, in order to prevent overly compression, between the circuit board or the electronic component to be electrically connected by the pressure contact holding-type connector and the housing.

4. The pressure contact-holding type connector described claim 1 in which the coil spring is shaped to have different configurations relative to the diameters of adjacent coil turns.

5. The pressure contact holding-type connector described in claim 3 in which either one of the corner portions at the lower side of the housing is chamfered.

6. The pressure contact holding-type connector described in claim 1 in which the housing is provided, on the back surface between the conductive plates as disposed with a rib which prevents wrapping-around of solder.

7. The pressure contact holding-type connector described in claim 2 in which an end stop is provided, in order to prevent overly compression, between the circuit board or the electronic component to be electrically connected by the pressure contact holding-type connector and the housing.

8. The pressure contact-holding type connector described in claim 2 in which the coil spring is shaped to have different configurations relative to the diameters of adjacent coil turns.

9. The pressure contact-holding type connector described in claim 3 in which the coil spring is shaped to have different configurations relative to the diameters of adjacent coil turns.

10. The pressure contact holding-type connector described in claim 4 in which either one of the corner portions at the lower side of the housing is chamfered.

11. The pressure contact holding-type connector described in claim 2 in which the housing is provided, on the back surface between the conductive plates as disposed with a rib which prevents wrapping-around of solder.

12. The pressure contact holding-type connector described in claim 3 in which the housing is provided, on the back surface between the conductive plates as disposed with a rib which prevents wrapping-around of solder.

13. The pressure contact holding-type connector described in claim 4 in which the housing is provided, on the back surface between the conductive plates as disposed with a rib which prevents wrapping-around of solder.

14. The pressure contact holding-type connector described in claim 5 in which the housing is provided, on the back surface between the conductive plates as disposed with a rib which prevents wrapping-around of solder.
